(19) United States
(12) Patent Application Publication
(10) Pub. No.: US 2025/0078195 A1
(43) Pub. Date: Mar. 6, 2025

(54) INFORMATION MANAGEMENT DEVICE, SERVICE PROVISION SYSTEM, NON-TRANSITORY COMPUTER-READABLE STORAGE MEDIUM, AND INFORMATION MANAGEMENT METHOD

(71) Applicant: Mitsubishi Electric Corporation, Tokyo (JP)

(72) Inventors: Tomoya UEFUNE, Tokyo (JP); Kotoyu SASAYAMA, Tokyo (JP); Atsushi HORI, Tokyo (JP)

(73) Assignee: Mitsubishi Electric Corporation, Tokyo (JP)

(21) Appl. No.: 18/953,355

(22) Filed: Nov. 20, 2024

Related U.S. Application Data
(63) Continuation of application No. PCT/JP2022/024131, filed on Jun. 16, 2022.

(51) Int. Cl. G06Q 50/40; B60W 60/00; G06Q 30/0207

(52) U.S. Cl. CPC G06Q 50/40; G06Q 30/0224; B60W 60/001; B60W 2556/10

(57) ABSTRACT

An information management device includes: a storage unit and a comparator unit. The storage unit stores setting information indicating stance and payable points; stance indicates whether a user boarding a host vehicle is to yield to a target vehicle or is to be given right of way by the target vehicle, when the travel paths of the vehicles intersect; the payable points are the upper limit of payment points to be paid to the user boarding the target vehicle when the target vehicle changes its path. The comparator unit refers to the setting information when a first traveling device of a first vehicle detects a second vehicle as the target vehicle, and compares the stance and the payable points of a first user boarding the first vehicle with those of a second user boarding the second vehicle, to determine the vehicle to change its travel path and the payment points.

### CROSS REFERENCE TO RELATED APPLICATION

This application is a continuation application of International Application No. PCT/JP2022/024131 having an international filing date of Jun. 16, 2022.

### BACKGROUND OF THE INVENTION

### 1. Field of the Invention

The disclosure relates to an information management device, a service provision system, a non-transitory computer-readable storage medium, and an information management method.

### 2. Description of the Related Art

PTL 1 discloses a system proving a vehicle control device that allows vehicles to safely and smoothly pass through an intersection with minimum required deceleration.

Specifically, when an intersecting vehicle is detected to possibly intersect a host vehicle at an intersection in front of the host vehicle, the vehicle control device providing braking control for the host vehicle sets priorities for the host vehicle and the intersecting vehicle regarding the passing of the intersection. When the priority of the host vehicle is lower than that of the intersecting vehicle, the vehicle control device provides braking control of the host vehicle so that the host vehicle passes through the intersection after the intersecting vehicle passes through the intersection.

The priorities are set for vehicles on the basis of the relative positional relationship between vehicles that possibly intersecting each other and/or on the basis of vehicle information and/or driver information stored in the form of a database. The vehicle information is information indicating, for example, an emergency vehicle such as an ambulance, a patrol car, or a fire engine. The driver information is, for example, information on fee payment for becoming a priority vehicle, information indicating the number of times a vehicle has deferred its priority in the past, or information indicating that the driver is a good driver who has not committed any traffic violations.

Such a conventional technology has provided useful services to people who are in a hurry, depending on their vehicle information and driver information. In the conventional technology, when a driver is not in a hurry, they can collect points by transferring the priority status of the vehicle to another driver, and when the driver is in a hurry, they can use points to preferentially establish a priority status.

In the conventional technology, in a situation where either a first vehicle or a second vehicle needs to yield, the first vehicle may yield to the second vehicle and earn points; these points then can be exchanged for certain services, such as receiving discounts on fees or obtaining a priority status for a vehicle.”
Patent Literature 1: Japanese Patent Application Publication No. 2007-045350

### SUMMARY OF THE INVENTION

However, in the conventional technology, a priority status can be purchased with money, and points can be obtained from a service provider by transferring a purchased priority status of a vehicle to another vehicle; the transfer of the priority status must be determined manually, and this manual action becomes a factor that hinders the operation of a passenger while the vehicle is performing autonomous driving.

Accordingly, it is an object of one or more aspects of the disclosure to enable automatic changing of a travel path and transfer of corresponding points in accordance with predetermined settings.

An information management device according to an aspect of the disclosure includes: storage to store setting information indicating stance and payable points and history information indicating history of each user, the stance indicating whether a user boarding a host vehicle is to yield to a target vehicle or is to be given way by the target vehicle when a travel path of the host vehicle intersects a travel path of the target vehicle, the payable points being an upper limit of payment points to be paid to the user boarding the target vehicle when the target vehicle changes the travel path to give right of way to the host vehicle; a processor to execute a program; and a memory to store the program which, when executed by the processor, performs processes of, determining whether a first vehicle or a second vehicle is to change the travel path and determining the payment points by referring to the setting information when a first traveling device mounted to the first vehicle and controlling traveling of the first vehicle detects the second vehicle, and by comparing the stance and the payable points of a first user boarding the first vehicle with the stance and the payable points of a second user boarding the second vehicle, the second vehicle being the target vehicle of the first vehicle. When the stance of the first user and the stance of the second user are different, the processor changes the travel path of the vehicle boarded by a user who is set to yield to the target vehicle and sets predetermined points as the payment points. When the stance of the first user and the stance of the second user both indicate yielding to the target vehicle, the processor changes the travel path of the vehicle having fewer payable points and sets a number of points equal to or larger than the fewer payable points as the payment points, whereas if the payable points payable by the first user and the payable points payable by the second user are the same, the processor refers to the history information, calculates intensity, changes the travel path of the user having lower intensity, and sets predetermined points as the payment points, the intensity increasing as the number of times the user has been given right of way increases.

According to one or more aspects of the disclosure, a travel path can be automatically changed and corresponding points can be transferred in accordance with predetermined settings.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically illustrating a configuration of a service provision system according to first and second embodiments;

FIG. 2 is a block diagram schematically illustrating a configuration of an information management device according to the first and second embodiments;

FIG. 3 is a block diagram illustrating a hardware configuration example of the information management device;

FIG. 4 is a block diagram schematically illustrating a configuration of a first traveling device according to the first and second embodiments;

FIG. 5 is a block diagram illustrating a hardware configuration example of a traveling device;

FIG. 6 is a block diagram schematically illustrating a configuration of a second traveling device according to the first and second embodiments;

FIG. 7 is a sequence diagram used to explain operation of the service provision system according to the first embodiment;

FIG. 8 is a flowchart illustrating operation performed by a comparator unit of the information management device;

FIG. 9 is a schematic diagram for explaining a specific example of the decision of changing a travel path and the determination of payment points according to the first embodiment;

FIG. 10 is a schematic diagram illustrating a first mechanism of transferring points;

FIG. 11 is a schematic diagram illustrating a second mechanism of transferring points;

FIG. 12 is a flowchart illustrating the operation of generating a vehicle group in a second embodiment; and

FIG. 13 is a schematic diagram for explaining a specific example of the decision of changing a travel path and the determination of payment points according to the second embodiment.

### DETAILED DESCRIPTION OF THE INVENTION

### First Embodiment

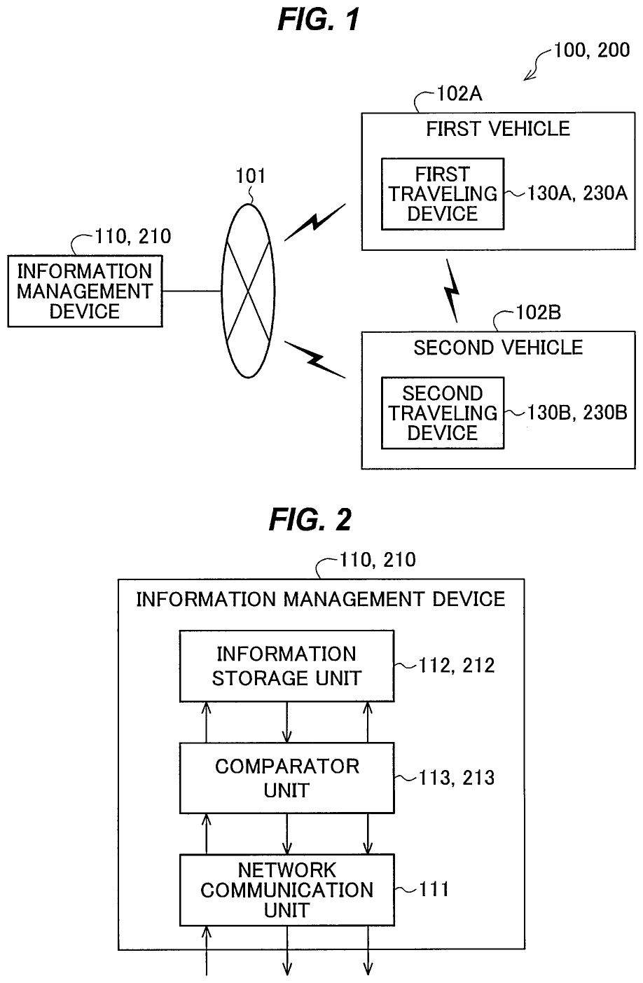

FIG. 1 is a block diagram schematically illustrating a configuration of a service provision system 100 according to the first embodiment.

The service provision system 100 includes an information management device 110, a first traveling device 130A, and a second traveling device 130B.

The information management device 110, and the first traveling device 130A or the second traveling device 130B can communicate with each other through a network 101, such as the Internet.

The first traveling device 130A is mounted on a first vehicle 102A and provides drive control for the first vehicle 102A; the second traveling device 130B is mounted on a second vehicle 102B and provides drive control for the second vehicle 102B. Since the first traveling device 130A and the second traveling device 130B have the same configuration, when there is no need to specifically distinguish between the first traveling device 130A and the second traveling device 130B, the first traveling device 130A and the second traveling device 130B are each referred to as a traveling device 130.

In the case where there are two vehicles traveling to travel paths intersecting each other, the traveling device 130 that first detects the other traveling device 130 and attempts to communicate with the other traveling device 130 is defined as the first traveling device 130A, and the other traveling device 130 is defined as the second traveling device 130B.

The information management device 110 manages information on users of the service provision system 100.

FIG. 2 is a block diagram schematically illustrating a configuration of the information management device 110.

The information management device 110 includes a network communication unit 111, an information storage unit 112, and a comparator unit 113.

The network communication unit 111 performs communication through the network 101. For example, the network communication unit 111 communicates with the first traveling device 130A or the second traveling device 130B via the network 101.

The information storage unit 112 stores programs and information necessary for processing executed by the information management device 110. For example, the information storage unit 112 stores setting information that is information on users of the service provision system 100. Here, the setting information indicates stance and payable points; stance indicates whether a user boarding a host vehicle is to yield to a target vehicle or is to be given way by the target vehicle, for example, when the travel path of the host vehicle intersects the travel path of the target vehicle; the payable points are the upper limit of payment points to be paid to the user boarding the target vehicle when the target vehicle changes its travel path to give way to the host vehicle.

The setting information is information that reflects the characteristics of vehicle passengers. This information is linked to users, not vehicles. Therefore, when a user boards a vehicle, an authentication procedure needs to be performed for the information management device 110 so that the information management device 110 recognizes the user. Detailed explanation of the authentication procedure is omitted because any known procedure may be applied, such as a procedure that uses an ID or a password, or a procedure that uses biometric information. The setting information is associated with user identification information for identifying users, and is also associated with vehicle identification information for identifying vehicles through an authentication procedure performed with the traveling device 130.

Specifically, the setting information is information indicating stance, payable points, and owned points.

The stance indicates whether a user wants to “proceed” or “yield” when the travel path of the host vehicle boarded by the user intersects the travel path of a target vehicle. Even if the stance indicates “proceed,” whether to actually proceed or yield is determined according to the stance of the user of the target vehicle and the maximum number of points payable by the user of the target vehicle. Similarly, even if the stance indicates “yield,” whether to actually proceed or yield is determined according to the stance of the user of the target vehicle.

The payable points are the maximum points that a user can pay to proceed the vehicle boarded by the user. It is assumed that the number of points payable is equal to or more than the number of minimum set points, which is a predetermined number of points.

The owned points are points owned by a user. If the points owned by a user are managed by another system such as another service operator, the owned points may not be included in the setting information. In such a case, the comparator unit 113 to be described later should check the points owned by the user by inquiring with the corresponding system through the network communication unit 111.

The information storage unit 112 stores history information for each user indicating a history recorded together with date and time, such as whether a user's vehicle has yielded to a target vehicle or has been give right of way from a target vehicle. The history information may include payment points received or paid.

When the travel path of a host vehicle boarded by a user intersects the travel path of a target vehicle, the comparator unit 113 decides which vehicle is to change its travel path by comparing the setting information of the user of the host vehicle and the setting information of the user of the target vehicle. Both vehicles receive path change information as a notification about the result of the decision.

Specifically, the comparator unit 113 refers to the setting information when the first traveling device 130A controlling the traveling of the first vehicle 102A detects the second vehicle 102B, which is a target of the first vehicle 102A, and compares the stance and payable points of a first user who boards the first vehicle 102A and the stance and payable points of a second user who boards the second vehicle 102B, to decide whether the first vehicle 102A or the second vehicle 102B changes its travel path and determine the payment points.

For example, when the stance of the first user differs from the stance of the second user, the comparator unit 113 changes the travel path of the vehicle boarded by the user who is set to yield to the target vehicle, and pays a predetermined number of points as payment points.

When the stance of the first user and the stance of the second user indicate that both vehicles are to be given right of way from a target vehicle, the comparator unit 113 changes the travel path of the vehicle boarded by the user having fewer payable points and pays payment points that is greater than or equal to the payable points that is fewer. Here, for example, the number of payment points may be determined by adding “1” to the number of payable points.

When the points payable by the first user and the points payable by the second user are the same, the comparator unit 113 refers to the history information, calculates intensity that increases as the number of times the user has been given way increases, changes the travel path of the user having the lower intensity, and sets predetermined points as payment points. Here, the comparator unit 113 calculates the intensity by multiplying the number of times by a value that decrease as the number of days passed from the last time right of way has been given increases.

The comparator unit 113 sends, via the network communication unit 111, path change information indicating an instruction for changing the travel path to the traveling device 130 mounted on the vehicle whose travel path is to be changed.

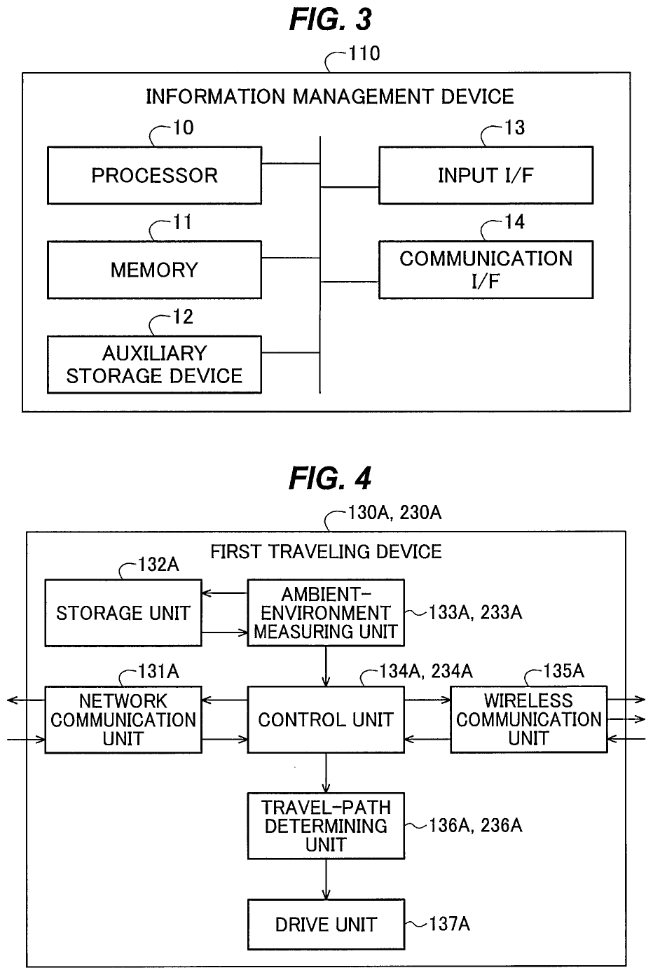

FIG. 3 is a block diagram illustrating a hardware configuration example of the information management device 110.

The information management device 110 can be implemented by a so-called computer, for example, including a processor 10, a memory 11, an auxiliary storage device 12, such as a hard disk drive (HDD), an input interface (I/F) 13, such as a keyboard or a mouse, and a communication I/F 14, such as a network interface card (NIC) for connecting to the network 101.

The network communication unit 111 can be implemented by the processor 10 using the communication I/F 14.

The information storage unit 112 can be implemented by the processor 10 using the memory 11 or the auxiliary storage device 12.

The comparator unit 113 can be implemented by the processor 10 loading programs stored in the auxiliary storage device 12 to the memory 11 and executing the programs.

Such programs may be provided over the network 101 or may be recorded and provided on a recording medium. That is, such programs may be provided, for example, as a program product.

FIG. 4 is a block diagram schematically illustrating a configuration of the first traveling device 130A.

The first traveling device 130A and the second traveling device 130B have the same configuration; when travel paths of two vehicles intersect, as described above, the traveling device 130 that detects the other vehicle first and attempts communication is defined as the first traveling device 130A, and thus the processing executed by the traveling device 130 that detects the other vehicle first will be explained as the processing executed by the first traveling device 130A.

The first traveling device 130A includes a network communication unit 131A, a storage unit 132A, an ambient-environment measuring unit 133A, a control unit 134A, a wireless communication unit 135A, a travel-path determining unit 136A, and a drive unit 137A.

The network communication unit 131A performs communication through the network 101. For example, the network communication unit 131A communicates with the information management device 110 through the network 101. Specifically, the network communication unit 131A sends a path-change-information acquisition request to be described later to the information management device 110 and receives path change information as a response.

The storage unit 132A stores information and programs necessary for processing executed by the first traveling device 130A. For example, the storage unit 132A stores map information indicating a map around at least the first vehicle 102A.

The ambient-environment measuring unit 133A generates ambient environment information indicating a map around the first vehicle 102A and the surroundings of the first vehicle 102A from GPS information from a global positioning system (GPS) receiver to be described later, map information stored in the storage unit 132A, and sensing information from a sensor to be described later. The generated ambient environmental information is given to the control unit 134A. The surroundings include information indicating the presence of an object that affects operation, such as an obstacle.

The ambient-environment measuring unit 133A detects, on the basis of the sensing information from a sensor to be described later, a target vehicle that is a vehicle within a predetermined range from the first vehicle 102A and is traveling in the direction of the travel path of the first vehicle 102A. The ambient-environment measuring unit 133A then estimates the travel path of the target vehicle from a direction vector indicating the speed of the target vehicle and determines whether or not the travel path of the first vehicle 102A intersects the travel path of the target vehicle.

When the target vehicle is detected, and the travel path of the target vehicle intersects the travel path of the first vehicle 102A, the ambient-environment measuring unit 133A gives target-vehicle detection information indicating that the target vehicle has been detected to the control unit 134A.

Specifically, in the case of a road such as a sidewalk, the ambient-environment measuring unit 133A estimates the travel path of the target vehicle from a direction vector indicating the speed of the target vehicle and determines whether or not the estimated travel path intersects the travel path of the first vehicle 102A. When the first vehicle 102A is to pass an entrance/exit of a store or the like, and the target vehicle is estimated to pass the entrance/exit on the basis of a direction vector indicating the speed of the target vehicle, the ambient-environment measuring unit 133A determines that the travel paths of the first vehicle 102A and the target vehicle intersect.

The control unit 134A controls the processing executed by the first traveling device 130A.

For example, the control unit 134A processes the path change information received by the network communication unit 131A, the ambient environment information or the target-vehicle detection information from the ambient-environment measuring unit 133A, or the target vehicle information from the wireless communication unit 135A, and sends the appropriate information corresponding to the next processing to the respective units.

Specifically, the control unit 134A instructs the ambient-environment measuring unit 133A to update the ambient environment information at a constant sampling time.

The control unit 134A receives the target-vehicle detection information from the ambient-environment measuring unit 133A and then sends a target-vehicle-information acquisition request to the wireless communication unit 135A to instruct communication with the target vehicle. If the communication is successful, the control unit 134A receives target vehicle information including vehicle identification information of the target vehicle from the wireless communication unit 135A. Next, the control unit 134A sends a path-change-information acquisition request including the vehicle identification information of the first vehicle 102A and the vehicle identification information of the second vehicle 102B, which is the target vehicle, to the information management device 110 via the network communication unit 131A.

The control unit 134A then receives path change information from the network communication unit 131A, receives the latest ambient environment information from the ambient-environment measuring unit 133A, and then sends a path determination instruction including these pieces of information to the travel-path determining unit 136A.

The wireless communication unit 135A performs communication by using radio waves. For example, the wireless communication unit 135A communicates with the second traveling device 130B by using radio waves. Here, the communication method is not particularly specified so long as the communication range is 10 m or more.

Specifically, the wireless communication unit 135A transmits the target-vehicle-information acquisition request to the second traveling device 130B in accordance with the communication instruction from the control unit 134A. The target-vehicle-information acquisition request is a request for necessary information from the target vehicle, and also indicates that the first vehicle 102A uses the same service as the target vehicle and that their travel paths intersect so that the target vehicle specifies the first vehicle 102A as a communication partner.

When the wireless communication unit 135A successfully communicates with the second traveling device 130B, the wireless communication unit 135A receives target vehicle information from the second traveling device 130B. The received target vehicle information is given to the control unit 134A.

The travel-path determining unit 136A determines a travel path in accordance with the path determination instruction received from the control unit 134A. For example, at a starting point, the travel-path determining unit 136A determines a travel path to a destination. When the path determination instruction is received from the control unit 134A after departure, the travel-path determining unit 136A determines a travel path on the basis of the path change information and the ambient environment information included in the path determination instruction.

Specifically, if the path change information indicates no change in the path and if the surroundings indicated in the ambient environment information indicate that no obstacle is present on the travel path of the first traveling device 130A, the travel-path determining unit 136A gives path information indicating the original travel path with no change to the drive unit 137A.

In contrast, if the path change information indicates a change in the path and/or if the surroundings indicated in the ambient environment information indicate that there is an obstacle on the travel path of the first vehicle 102A, the travel-path determining unit 136A refers to the ambient map information included in the ambient environment information, changes the travel path of the first vehicle 102A so as to avoid at least one of the target vehicle and the obstacle, and gives the path information indicating the resulting travel path to the drive unit 137A.

The drive unit 137A generates a time-series voltage value for controlling the first vehicle 102A or a control signal for wheel angle or the like in accordance with the path information from the travel-path determining unit 136A, and sends the generated control signal to a vehicle control circuit described later. Specifically, the drive unit 137A calculates time-series movement such as acceleration and deceleration or curve angle on the basis of the path information and coverts this into a control signal for driving the first vehicle 102A.

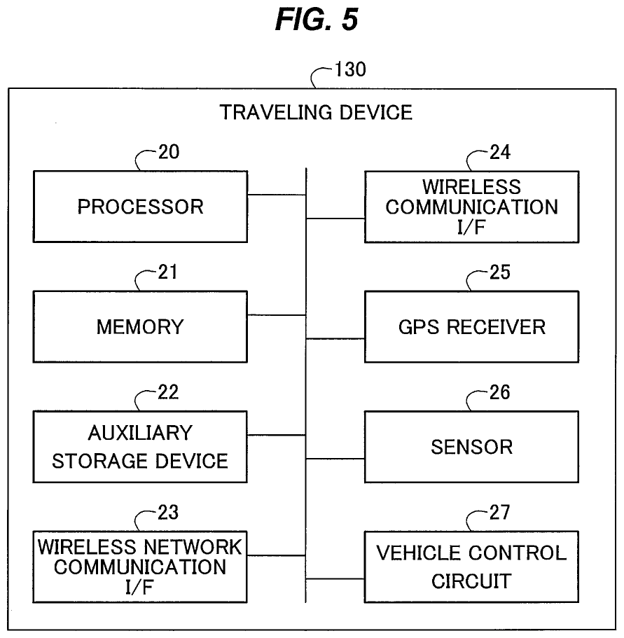

FIG. 5 is a block diagram illustrating a hardware configuration example of a traveling device 130.

A traveling device 130 can be implemented by a so-called computer including, for example, a processor 20, a memory 21, an auxiliary storage device 22, such as an HDD, a wireless network communication I/F 23, such as an NIC for connecting to the network 101 with radio waves, a wireless communication I/F 24 for performing wireless communication, a GPS receiver 25, a sensor 26, and a vehicle control circuit 27.

The network communication unit 131A can be implemented by the processor 20 using the wireless network communication I/F 23.

The storage unit 132A can be implemented by the processor 20 using the memory 21 or the auxiliary storage device 22.

The ambient-environment measuring unit 133A, the control unit 134A, the travel-path determining unit 136A, and the drive unit 137A can be implemented by the processor 20 loading the programs stored in the auxiliary storage device 22 to the memory 21 and executing the processors.

The ambient-environment measuring unit 133A receives information from the GPS receiver 25 and the sensor 26, which serve as measurement execution units, and generates ambient environment information.

The drive unit 137A gives the control signal to the vehicle control circuit 27.

Such programs may be provided over the network 101 or may be recorded and provided on a recording medium. That is, such programs may be provided, for example, as a program product.

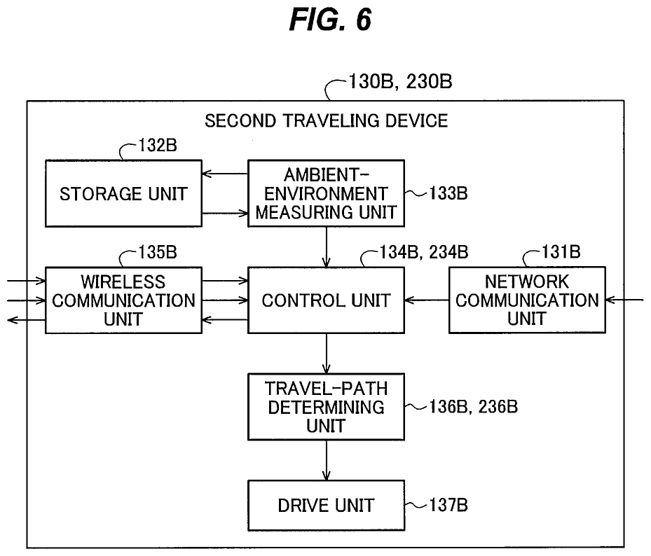

FIG. 6 is a block diagram schematically illustrating a configuration of the second traveling device 130B.

The first traveling device 130A and the second traveling device 130B have the same configuration; when travel paths of two vehicles intersect, as described above, the traveling device 130 that detects the other vehicle first and attempts communication is defined as the first traveling device 130A, the detected traveling device 130 is defined as the second traveling device 130B, and thus the processing executed by the traveling device 130 detected by the other traveling device 130 will be explained as the processing executed by the second traveling device 130B.

The second traveling device 130B includes a network communication unit 131B, a storage unit 132B, an ambient-environment measuring unit 133B, a control unit 134B, a wireless communication unit 135B, a travel-path determining unit 136B, and a drive unit 137B.

The network communication unit 131B performs communication through the network 101. For example, the network communication unit 131B communicates with the information management device 110 through the network 101. Specifically, the network communication unit 131B receives path change information from the information management device 110.

The storage unit 132B stores information and programs necessary for processing executed by the second traveling device 130B. For example, the storage unit 132B stores map information indicating a map around at least the second vehicle 102B.

The ambient-environment measuring unit 133B generates ambient environment information indicating a map around the second vehicle 102B and the surroundings of the second vehicle 102B from GPS information from the GPS receiver 25, map information stored in the storage unit 132B, and sensing information from the sensor 26. The generated ambient environmental information is given to the control unit 134B.

The control unit 134B controls the processing executed by the second traveling device 130B.

For example, the control unit 134B processes the path change information received by the network communication unit 131B, the ambient environment information from the ambient-environment measuring unit 133B, or a target-vehicle-information acquisition request from the wireless communication unit 135B, and sends the appropriate information corresponding to the next processing to the respective units.

Specifically, the control unit 134B instructs the ambient-environment measuring unit 133B to update the ambient environment information at a constant sampling time.

When the control unit 134B receives the target-vehicle-information acquisition request from the wireless communication unit 135B, the control unit 134B generates target vehicle information including vehicle identification information of the second vehicle 102B and sends the generated target vehicle information to the first traveling device 130A via the wireless communication unit 135B.

Furthermore, the control unit 134B then receives path change information from the network communication unit 131B, receives the latest ambient environment information from the ambient-environment measuring unit 133B, and then sends a path determination instruction including these pieces of information to the travel-path determining unit 136B.

The wireless communication unit 135B performs communication by using radio waves. For example, the wireless communication unit 135B communicates with the first traveling device 130A by using radio waves.

Specifically, the wireless communication unit 135B receives a target-vehicle-information acquisition request from the first traveling device 130A.

The wireless communication unit 135B transmits the target vehicle information from the control unit 134B to the first traveling device 130A.

The travel-path determining unit 136B determines a travel path in accordance with path determination instruction from the control unit 134B. For example, at a starting point, the travel-path determining unit 136B determines a travel path to a destination. When the path determination instruction is received from the control unit 134B after departure, the travel-path determining unit 136B determines a travel path on the basis of the path change information and the ambient environment information included in the path determination instruction. The travel-path determining unit 136B gives the path information indicating the determined travel path to the drive unit 137B.

The drive unit 137B generates a time-series voltage value for controlling the second vehicle 102B or a control signal for wheel angle or the like in accordance with the path information from the travel-path determining unit 136B, and sends the generated control signal to the vehicle control circuit 27.

The second traveling device 130B also has the hardware configuration illustrated in FIG. 5.

For example, the network communication unit 131B can be implemented by the processor 20 using the wireless network communication I/F 23.

The storage unit 132B can be implemented by the processor 20 using the memory 21 or the auxiliary storage device 22.

The ambient-environment measuring unit 133B, the control unit 134B, the travel-path determining unit 136B, and the drive unit 137B can be implemented by the processor 20 loading the programs stored in the auxiliary storage device 22 to the memory 21 and executing the processors.

The ambient-environment measuring unit 133B receives information from the GPS receiver 25 and the sensor 26 and generates ambient environment information.

The drive unit 137B gives a control signal to the vehicle control circuit 27.

Such programs may be provided over the network 101 or may be recorded and provided on a recording medium. That is, such programs may be provided, for example, as a program product.

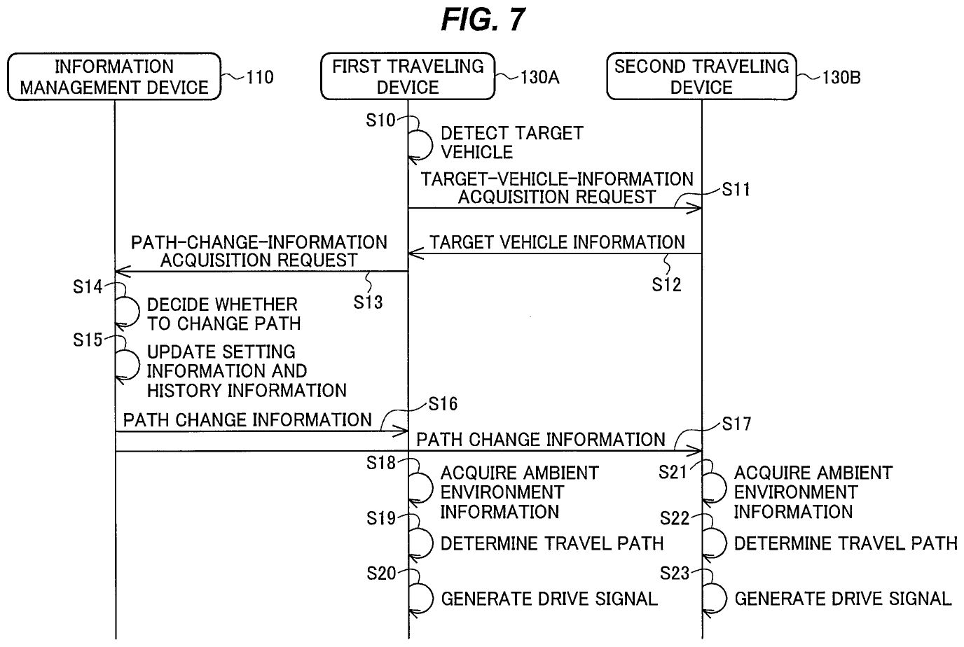

FIG. 7 is a sequence diagram used to explain operation of the service provision system 100 according to the first embodiment.

When the ambient-environment measuring unit 133A of the first traveling device 130A detects a target vehicle whose travel path intersects the traveling path of the first vehicle 102A (step S10), the ambient-environment measuring unit 133A then gives target-vehicle detection information indicating the detection of the target vehicle to the control unit 134A.

When the control unit 134A receives the target-vehicle detection information, the control unit 134A sends a target-vehicle-information acquisition request to the wireless communication unit 135A, and the wireless communication unit 135A sends the received target-vehicle-information acquisition request to the second traveling device 130B (step S11).

When the wireless communication unit 135B of the second traveling device 130B receives the target-vehicle-information acquisition request, the wireless communication unit 135B gives the target-vehicle-information acquisition request to the control unit 134B, and the control unit 134B generates target vehicle information including vehicle identification information of the second vehicle 102B and sends the generated target vehicle information to the wireless communication unit 135B. The wireless communication unit 135B transmits the target vehicle information to the first traveling device 130A (step S12).

When the wireless communication unit 135A of the first traveling device 130A receives target vehicle information from the second traveling device 130B, the wireless communication unit 135A gives the received target vehicle information to the control unit 134A. The control unit 134A generates a path-change-information acquisition request including the vehicle identification information of the first vehicle 102A and the vehicle identification information of the second vehicle 102B, and gives the generated path-change-information acquisition request to the network communication unit 131A. The network communication unit 131A transmits the path-change-information acquisition request to the information management device 110 (step S13).

When the network communication unit 111 of the information management device 110 receives the path-change-information acquisition request, the network communication unit 111 gives the received path-change-information acquisition request to the comparator unit 113.

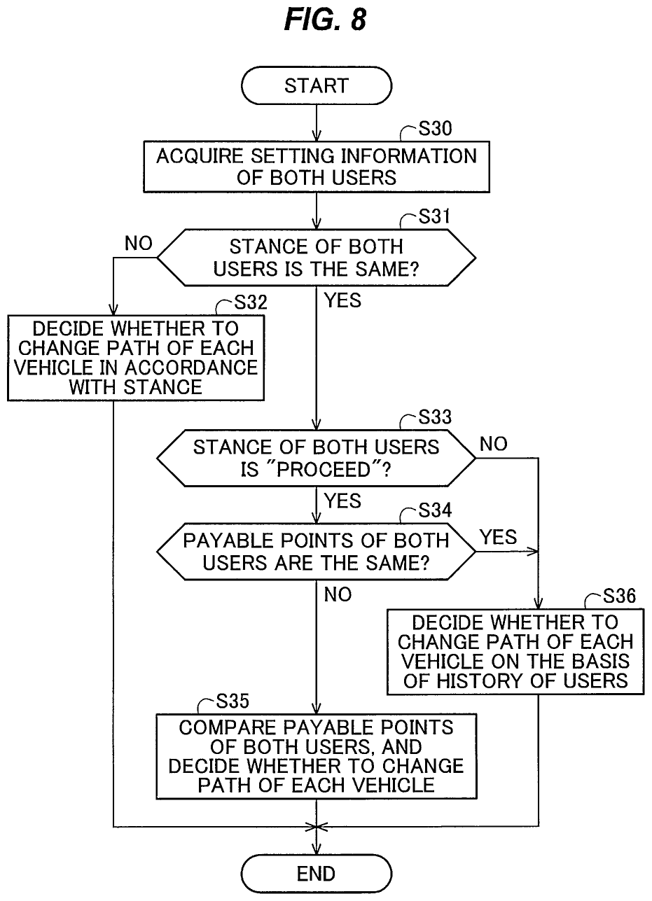

The comparator unit 113 reads, from the information storage unit 112, setting information (hereinafter, referred to as first setting information) and history information (hereinafter, referred to as first history information) of users associated with the vehicle identification information of the first vehicle 102A, and setting information (hereinafter, referred to as second setting information) and history information (hereinafter, referred to as second setting information) of users associated with the vehicle identification information of the second vehicle 102B, and compares the first setting information, the first history information, the second setting information, and the second history information to decides whether to change the travel path of any one of the first vehicle 102A and the second vehicle 102B (step S14). The details of the processing herein will be described with reference to FIG. 8.

Next, the comparator unit 113 updates the setting information and the history information stored in the information storage unit 112 in accordance with the decision in step S14 (step S15). For example, the comparator unit 113 subtracts payment points from the points owned by the user who has been give right of way and adds the payment points to the points owned by the user who yielded in the setting information, and stores the history of giving right of way and the history of yielding in the history information together with the users and the year, month, day, and time.

Next, the comparator unit 113 generates path change information indicating the travel path is to be changed for the traveling device 130 of the vehicle boarded by the user who has yielded, generates path change information indicating that the travel path is not to be changed for the traveling device 130 boarded by the user who was given right of way, and gives the generated path change information to the network communication unit 111. The network communication unit 111 transmits the path change information to the first traveling device 130A and the second traveling device 130B (steps S16 and S17). Here, the explanation is based on the assumption that the user of the first vehicle 102A is to yield, and the user of the second vehicle 102B is to be given right of way.

When the network communication unit 131A of the first traveling device 130A receives the path change information, the network communication unit 131A gives the received path change information to the control unit 134A. The control unit 134A instructs the ambient-environment measuring unit 133A to acquire the latest ambient environment information (step S18). Then, the control unit 134A sends a path determination instruction including the path change information and the ambient environment information to the travel-path determining unit 136A.

The travel-path determining unit 136A determines a travel path in accordance with the path determination instruction received from the control unit 134A (step S19) Here, since the first vehicle 102A has yielded to the second vehicle 102B, the travel-path determining unit 136A changes the travel path of the first vehicle 102A so that the second vehicle 102B can pass preferentially, and gives path information indicating the changed travel path to the drive unit 137A.

The drive unit 137A generates a control signal for controlling a vehicle (not illustrated) in accordance with the path information provided from the travel-path determining unit 136A and sends the control signal to the vehicle control circuit 27 (step S20).

When the network communication unit 131B of the second traveling device 130B receives path change information, the network communication unit 131B gives the path change information to the control unit 134B. The control unit 134B instructs the ambient-environment measuring unit 133B to acquire the latest ambient environment information (step S21). Here, it is assumed that there are no obstacles on the travel path. Then, the control unit 134B sends a path determination instruction including the path change information and the ambient environment information to the travel-path determining unit 136B.

The travel-path determining unit 136B determines a travel path in accordance with the path determination instruction received from the control unit 134B (step S22) Here, since the second vehicle 102B has been given right of way from the first vehicle 102A, the travel-path determining unit 136B gives path information indicating the previous travel path to the drive unit 137B.

The drive unit 137B generates a control signal for controlling a vehicle (not illustrated) in accordance with the path information provided from the travel-path determining unit 136B and sends the control signal to the vehicle control circuit 27 (step S23).

FIG. 8 is a flowchart illustrating operation by the comparator unit 113 of the information management device 110.

The comparator unit 113 determines whether to change the travel path of the first vehicle 102A or the second vehicle 102B on the basis of the setting information and the history information of the users associated with the vehicles.

First, the comparator unit 113 uses the vehicle identification information included in the path-change-information acquisition request to acquire the setting information and the history information of the users associated with the first vehicle 102A and the second vehicle 102B from the information storage unit 112 (step S30).

Next, the comparator unit 113 determines whether or not the stances of the users boarding the first vehicle 102A and the second vehicle 102B are the same (step S31).

If the stances differ (No in step S31), the process proceeds to step S32, whereas if the stances are the same (Yes in step S31), the process proceeds to step S33.

In step S32, the comparator unit 113 decides not to change the travel path of the vehicle boarded by the user whose stance is “proceed,” and to change the travel path of the vehicle boarded by the user whose stance is “yield.” In this case, in step S15 in FIG. 7, a predetermined number of minimum set points is sent as payment points from the user whose stance is “proceed” to the user whose stance is “yield.”

In step S33, the comparator unit 113 determines whether or not the stance of both users is “proceed.” If the stance of both users is “proceed” (Yes in step S33), the process proceeds to step S34, whereas if the stance of both users is “yield” (No in step S33), the process proceeds to step S36.

In step S34, the comparator unit 113 determines whether or not the points payable by both users are the same. If the points payable by the users are different (No in step S34), the process proceeds to step S35, whereas if the points payable by the users are the same (Yes in step S34), the process proceeds to step S36.

In step S35, the comparator unit 113 compares the points payable by the users to determine the vehicle whose travel path is to be changed. Here, the comparator unit 113 determines that the travel path is not to be changed for the vehicle boarded by the user who has more payable points, and the travel path is to be changed for the vehicle boarded by the user who has fewer payable points.

In this case, in step S15 in FIG. 7, payment points that are determined by adding “1” to the points payable by the user who has fewer payable points are sent from the user who has more payable points to the user who has fewer payable points.

In step S36, the comparator unit 113 compares the histories of both users to determine the vehicle whose travel path is to be changed. Here, the comparator unit 113 determines this by using two parameters: the use history of the service and the history of granting points to other users. Specifically, the comparator unit 113 emphasizing the recent intensity on “proceeding” and calculates use intensity by multiplying “a parameter that decreases as more days pass after the last time a user is given right of way from another user” by “the number of times the user has given points to another user.” Then, the comparator unit 113 determines that the travel path is not to be changed for the vehicle boarded by the user whose use intensity is high, and the travel path is to be changed for the vehicle boarded by the user whose use intensity is low.

In this case, in step S15 in FIG. 7, a predetermined number of minimum set points is sent as payment points from the user whose use intensity is high to the user whose use intensity is low.

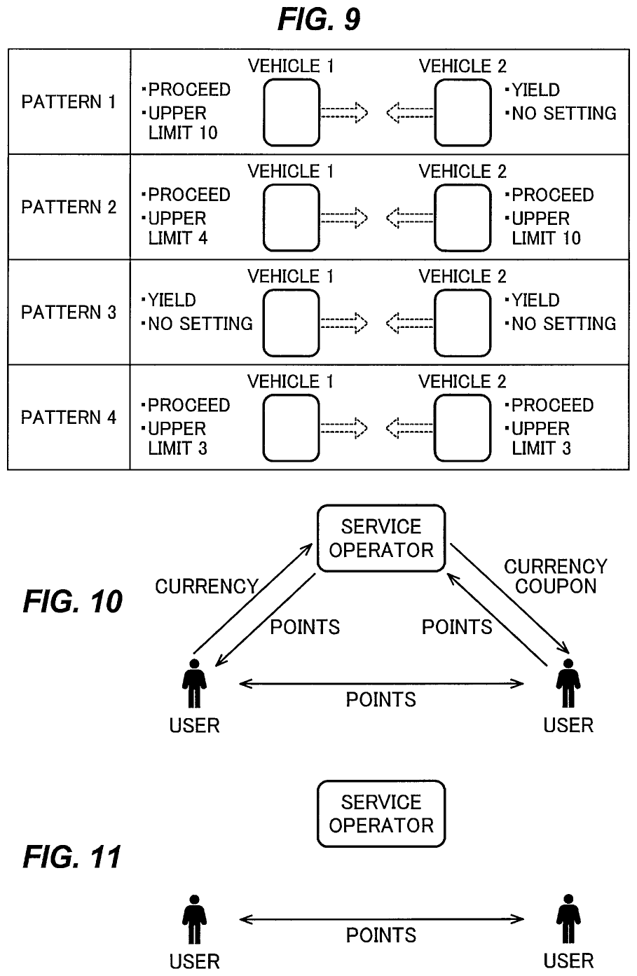

FIG. 9 is a schematic diagram for explaining a specific example of the decision of changing a travel path and the determination of payment points according to the first embodiment.

In Pattern 1 illustrated in FIG. 9, the stance in the setting information of the user of Vehicle 1 is “proceed,” and the stance in the setting information of the user of Vehicle 2 is “yield.” In Pattern 1, the user boarding Vehicle 1 pays “2 points,” which is the lower limit set for points, to the user boarding Vehicle 2, and as result, it is decided that the travel path of Vehicle 1 is not to be changed and the travel path of Vehicle 2 is to be changed.

In Pattern 2 illustrated in FIG. 9, the stance in the setting information of the user of Vehicle 1 is “proceed,” and the stance in the setting information of the user of Vehicle 2 is also “proceed.” In this case, the payable points are “4” in the setting information of user of Vehicle 1, and the payable points is “10” in the setting information of the user of Vehicle 2. Therefore, the user boarding Vehicle 2 pays “5 points,” which is determined by adding “1” to the four points payable by the user boarding Vehicle 1, to the user boarding Vehicle 1, and as result, it is decided that the travel path of Vehicle 2 is not to be changed and the travel path of Vehicle 1 is to be changed.

In Pattern 3 illustrated in FIG. 9, the stance in the setting information of the user of Vehicle 1 is “yield,” and the stance in the setting information of the user of Vehicle 2 is also “yield.” In this case, whether or not to change the travel path is decided on the basis of the user's history. Then, the user whose travel path was not changed pays “2 points,” which is the lower limit set for points, to the user whose travel path was changed.

In Pattern 4 illustrated in FIG. 9, the stance in the setting information of the user of Vehicle 1 is “proceed,” and the stance in the setting information of the user of Vehicle 2 is also “proceed.” The payable points are “3” in the setting information of user of Vehicle 1, and the payable points is also “3” in the setting information of the user of Vehicle 2. In this case, whether or not to change the travel path is decided on the basis of the user's history. Then, the user whose travel path was not changed pays “2 points,” which is the lower limit set for points, to the user whose travel path was changed.

When the vehicles are followed by many other vehicles, for example, when a traffic jam is occurring near an entrance/exit of a store, the method described in the first embodiment is not applied. In such a case, it is desirable for the traveling devices 130 to carry out traffic control through communication between the vehicles so that the vehicles alternately enter and exit.

The points used by the comparator unit 113 are assumed to consist those that can be used only for services provided by the supplier of the service provision system 100 and those that can be used outside such services. Examples of points that can be used outside such services include money and virtual currency.

In the case of points only used for services provided by the supplier of the service provision system 100, the points are circulated by, for example, a mechanism illustrated in FIG. 10. Basically, it is a mechanism in which points are transferred between users and, as a result, the points are circulated between users. Here, users are given points from the service operator at certain time intervals, and if a user desires more points, the user can acquire the points in exchange of, for example, money or virtual currency, which can be used outside the services. On the other hand, a user can acquire, for example, money or coupons, which can be used outside of the services, from the service operator in exchange of a certain number of points.

When points can be used outside the services provided by the provider of the service provision system 100, the points can be circulated also by a mechanism illustrated in FIG. 11. In FIG. 11, points circulate between users as a result of points being transferred between these users, and thus points are not exchanged with the service operator. However, in this mechanism, the service operator needs to know whether or not payments can be made with the points owned by the users in order to smoothly make payments while the system is operated. Therefore, the users need to deposit a certain number of points to the services.

As described above, in the first embodiment, points can be automatically sent from a user who wants to proceed preferentially to another user who is to yield on the basis of information indicating the intensity of priority pre-set by the users, and the travel paths of autonomous vehicles can be automatically reset. Therefore, a user who wants to proceed can experience less stress at when intersecting the travel path of a target vehicle by paying points, and can travel to a destination at high speed. On the other hand, a user who desires points can automatically obtain points simply by boarding in an autonomous vehicle and yielding.

### Second Embodiment

In the case where a host vehicle group and a target vehicle group are lined up on road, such as a narrow sidewalk, that requires one of two small vehicles facing each other to change its course, the sums of payable points of vehicle groups are compared. This case will be described as the second embodiment.

As illustrated in FIG. 1, a service provision system 200 according to the second embodiment includes an information management device 210, a first traveling device 230A, and a second traveling device 230B.

In the second embodiment, when there is no need to specifically distinguish between the first traveling device 230A and the second traveling device 230B, the first traveling device 230A and the second traveling device 230B are each referred to as a traveling device 230.

The first traveling device 230A is mounted on a first vehicle 102A, and the second traveling device 230B is mounted on a second vehicle 102B.

In the second embodiment, when two vehicles approach each other, the traveling device 230 that first detects the other traveling device 230 and attempts to communicate with the other traveling device 230 is defined as the first traveling device 230A, and the other traveling device 230 is defined as the second traveling device 230B.

The information management device 210 manages information on users of the service provision system 200.

As illustrated in FIG. 2, the information management device 210 according to the second embodiment includes a network communication unit 111, an information storage unit 212, and a comparator unit 213.

The network communication unit 111 of the information management device 210 according to the second embodiment is the same as the network communication unit 111 of the information management device 110 according to the first embodiment.

The information storage unit 212 stores programs and information necessary for processing executed by the information management device 210. For example, the information storage unit 212 stores setting information that is information on users using the service provision system 200.

The setting information in the second embodiment, as same as the setting information in the first embodiment, indicates stance, payable points, and owned points, and also indicates group identification information if a vehicle boarded by a user belongs to a group of other vehicles.

The comparator unit 213 according to the second embodiment executes the following processing in addition to the same processing as that executed by the comparator unit 113 according to the first embodiment.

When the comparator unit 213 receives a group registration request from the network communication unit 111, the comparator unit 213 registers, to the setting information of users boarding the vehicles identified in the vehicle identification information indicated in the group registration request, the group identification information indicating the group. For example, in this case, if the comparator unit 213 first receives, from a vehicle A, a group registration request indicating the vehicle identification information of vehicles A and B, and then receives a group registration request indicating the vehicle identification information of vehicles B and C or a group identification information indicating the vehicle identification information of vehicles A and C, the comparator unit 213 assigns, to the vehicles A, B, and C, group identification information indicating that the vehicles A, B, and C are in the same group. In other words, when the comparator unit 213 receives a group registration request including vehicles that are already registered as a group, the comparator unit 213 determines that the vehicles identified by other vehicle identification information included in the group registration request belong to the same group as the vehicles already registered.

When the comparator unit 213 determines, as described in the first embodiment, whether or not to change the travel path for users boarding vehicles belonging to a group, the comparator unit 213 performs the determination of steps S34 and S35 in FIG. 8 by using the sum of points payable by the users boarding all vehicles included in the group. In this case, the payable point is “0” for users whose stance is “yield.”

Specifically, when the first vehicle 102A belongs to a first vehicle group consisting of multiple vehicles sharing at least a portion of the travel path of the first vehicle 102A, and the second vehicle 102B belongs to a second vehicle group consisting of multiple vehicles sharing at least a portion of the travel path of the second vehicle 102B, the comparator unit 213 calculates the sum of points payable by the users boarding the vehicles in the first vehicle group, and the sum of points payable by the users boarding the vehicles in the second vehicle group. The comparator unit 213 then changes the travel paths of the vehicles included in the vehicle group whose sum is smaller, and causes the vehicle group whose sum is larger to share the payment of points more than or equal to the smaller sum. The method of sharing the payment of points within the vehicle group may be any method, so long that the method is predetermined. Here, for example, the sum of the payment points may be determined by adding “1” to the sum of points of the vehicle group whose sum is smaller.

When the calculated sums are the same, the comparator unit 213 changes the travel paths of the group that does not include the user whose payable points is the largest among the users boarding the vehicles in the first and second vehicle groups. The comparator unit 213, then, causes the group whose travel path was not changed to pay for the sum of payable points of the group whose travel path was changed. In this case, each user in the group whose travel paths were not changed pays a corresponding number of payable points. The method of distributing the payment points within the vehicle group may be any method, so long that the method is predetermined. For example, the points distributed may increase as the payable points increase, or the points may be distributed evenly.

When the calculated sums are the same, the comparator unit 213 changes the travel paths of the vehicle group not including the user who has paid points the most times among the users boarding the vehicles in the first and second vehicle group. The comparator unit 213 determines the payment points by multiplying the number of vehicles whose travel path was changed by a predetermined number of points and causing the other vehicles to share the payment of the points.

As illustrated in FIG. 4, the first traveling device 230A includes a network communication unit 131A, a storage unit 132A, an ambient-environment measuring unit 233A, a control unit 234A, a wireless communication unit 135A, a travel-path determining unit 236A, and a drive unit 137A.

The network communication unit 131A, the storage unit 132A, the wireless communication unit 135A, and the drive unit 137A of the first traveling device 230A according to the second embodiment are respectively the same as the network communication unit 131A, the storage unit 132A, the wireless communication unit 135A, and the drive unit 137A of the first traveling device 130A according to the first embodiment.

In the second embodiment, also, the first traveling device 230A and the second traveling device 230B have the same configuration; when two vehicles approach each other, as described above, the traveling device 230 that detects the other vehicle first and attempts communication is defined as the first traveling device 230A, and thus the processing executed by the traveling device 230 that detects the other vehicle first will be explained as the processing executed by the first traveling device 230A.

The ambient-environment measuring unit 233A executes the same processes as the ambient-environment measuring unit 133A according to the first embodiment, and also executes the following processes.

The ambient-environment measuring unit 233A detects, on the basis of the sensing information from a sensor 26, a parallel vehicle that is a vehicle within a predetermined range from the first vehicle 102A and is traveling in the same direction as the first vehicle 102A. The ambient-environment measuring unit 233A gives parallel-vehicle detection information indicating that a parallel vehicle has been detected to the control unit 234A.

The control unit 234A controls the processing executed by the first traveling device 230A.

The control unit 234A according to the second embodiment executes the same processes as the control unit 134A according to the first embodiment, and also executes the following processes.

The control unit 234A receives the parallel-vehicle detection information from the ambient-environment measuring unit 233A and then sends a parallel-vehicle-information acquisition request to the wireless communication unit 135A to instruct communication with the parallel vehicle. If the communication is successful, the control unit 234A receives, from the wireless communication unit 135A, parallel vehicle information including vehicle identification information of the parallel vehicle and parallel-vehicle travel-path information indicating the travel path of the parallel vehicle.

When the control unit 234A receives the parallel vehicle information, the control unit 234A sends a travel-path determination instruction to the travel-path determining unit 236A and acquires path information indicating the travel path of the first vehicle 102A as a response.

Next, the control unit 234A determines whether the travel path of the parallel vehicle and the travel path of the first vehicle 102A match at least up to an intermediate point. For example, when the travel path of the parallel vehicle and the travel path of the first vehicle 102A are the same for at least a predetermined distance, the control unit 234A determines the travel path of the parallel vehicle and the travel path of the first vehicle 102A match at least up to an intermediate point. When the travel path of the parallel vehicle and the travel path of the first vehicle 102A match at least up to an intermediate point, the control unit 234A sends a group registration request including vehicle identification information of the first vehicle 102A and vehicle identification information of the second vehicle 102B, which is the parallel vehicle, to the information management device 210 via the network communication unit 131A.

The travel-path determining unit 236A according to the second embodiment executes the same processes as the travel-path determining unit 136A according to the first embodiment, and also executes the following processes.

The travel-path determining unit 236A determines a travel path in accordance with path determination instruction from the control unit 234A. The travel-path determining unit 236A then gives the path information indicating the determined travel path to the control unit 234A.

As illustrated in FIG. 6, the second traveling device 230B includes a network communication unit 131B, a storage unit 132B, an ambient-environment measuring unit 133B, a control unit 234B, a wireless communication unit 135B, a travel-path determining unit 236B, and a drive unit 137B.

The network communication unit 131B, the storage unit 132B, the ambient-environment measuring unit 133B, the wireless communication unit 135B, and the drive unit 137B of the second traveling device 230B according to the second embodiment are respectively the same as the network communication unit 131B, the storage unit 132B, the ambient-environment measuring unit 133B, the wireless communication unit 135B, and the drive unit 137B of the second traveling device 130B according to the first embodiment.

The control unit 234B according to the second embodiment executes the same processes as the control unit 134B according to the first embodiment, and also executes the following processes.

When the control unit 234B receives a parallel-vehicle-information acquisition request from the wireless communication unit 135B, the control unit 234B sends a travel-path determination instruction to the travel-path determining unit 236B and acquires path information indicating a parallel vehicle travel path, which is the travel path of the second vehicle 102B, as a response.

The control unit 234B then generates parallel vehicle information including vehicle identification information of the second vehicle 102B and parallel-vehicle travel-path information, which is path information of the second vehicle 102B, and sends the parallel vehicle information to the first traveling device 230A via the wireless communication unit 135B.

The travel-path determining unit 236B according to the second embodiment executes the same processes as the travel-path determining unit 136B according to the first embodiment, and also executes the following processes.

The travel-path determining unit 236B determines a travel path in accordance with a path determination instruction received from the control unit 234B. The travel-path determining unit 236B also gives the path information indicating the determined travel path to the control unit 234B.

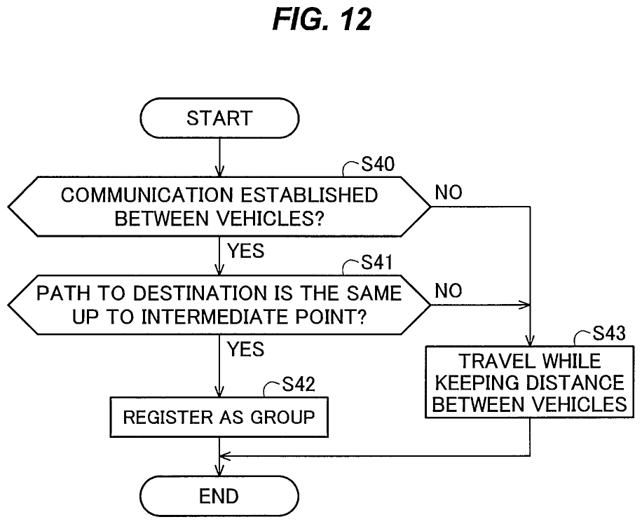

FIG. 12 is a flowchart illustrating the operation of generating a vehicle group in the second embodiment.

As described above, here, a case in which the first traveling device 230A detects the second vehicle 102B as a parallel vehicle is explained. Specifically, it is assumed that the first vehicle 102A approaches the second vehicle 102B from behind, and the first traveling device 230A first detects the presence of the second vehicle 102B.

First, the control unit 234A of the first traveling device 230A receives parallel-vehicle detection information from the ambient-environment measuring unit 233A and sends a parallel-vehicle-information acquisition request to the wireless communication unit 135A; then the wireless communication unit 135A transmits the parallel-vehicle-information acquisition request to the second traveling device 230B. The parallel-vehicle-information acquisition request indicates that the same service is used to enable the second traveling device 230B to specify the first traveling device 230A as a communication partner, and requests the transmission of parallel vehicle information. The control unit 234A then determines whether the communication with the second traveling device 230B has succeeded on the basis of whether the wireless communication unit 135A receives the parallel vehicle information (step S40). If the communication with the second traveling device 230B is successful (Yes in step S40), the process proceeds to step S41, whereas, if the communication with the second traveling device 230B fails (No in step S40), the process proceeds to step S43.

In step S41, the control unit 234A acquires the travel path of the first vehicle 102A from the travel-path determining unit 236A and compares the travel path of the first vehicle 102A with the travel path indicated in the parallel-vehicle travel-path information included in the received parallel vehicle information, to determine whether at least a portion of the path of the first vehicle 102A to a destination and a portion of the path of the second vehicle 102B to the destination are the same. Although a travel path to a destination usually consists of multiple roads, the control unit 234A determines that portions of the paths are the same if the vehicles are currently traveling longer than or equal to a predetermined distance on the same road. Specifically, for example, when the paths to the next traffic signal are the same, the control unit 234A determines that the portions of the paths are the same. If at least the portions of the paths are the same (Yes in step S41), the process proceeds to step S42, whereas, if the even portions of the paths are different (No in step S41), the process proceeds to step S43.

In step S42, the control unit 234A generates a group registration request including vehicle identification information of the second vehicle 102B included in the parallel vehicle information and vehicle identification information of the first vehicle 102A, and gives the group registration request to the network communication unit 131A; the network communication unit 131A transmits the group registration request to the information management device 210.

As described above, by registering a vehicle group to the information management device 210, the comparator unit 213 can use group information while reading the setting information of a user boarding a vehicle from the information storage unit 212, to also read the setting information of users boarding other vehicles belonging to the same group. In this way, the comparator unit 213 can calculate the total number of points payable by the vehicle group or can use history information of each user.

In the case of the processing a vehicle group, in order to refer to the setting information of all users boarding the vehicles in vehicle groups, for example, the comparator unit 213 makes a request to the information storage unit 212 to read the setting information of the users boarding the leading vehicles of the vehicle groups. Next, the comparator unit 213 calculates the number of points payable by the other vehicle on the basis of the group information of the leading vehicles of a host vehicle group and a target vehicle group, and executes the processing in the flowchart of FIG. 8. However, when the sums of points of the two vehicle groups are the same, adjustments are made in accordance with a predetermined determination method so that the group including a heavy user can proceed, i.e., the group including a user whose payable points is the highest or the group including a user has the most use history among all users boarding the vehicles in the host vehicle group and the target vehicle group. In such a case, the travel path of the group not including the heavy user is changed.

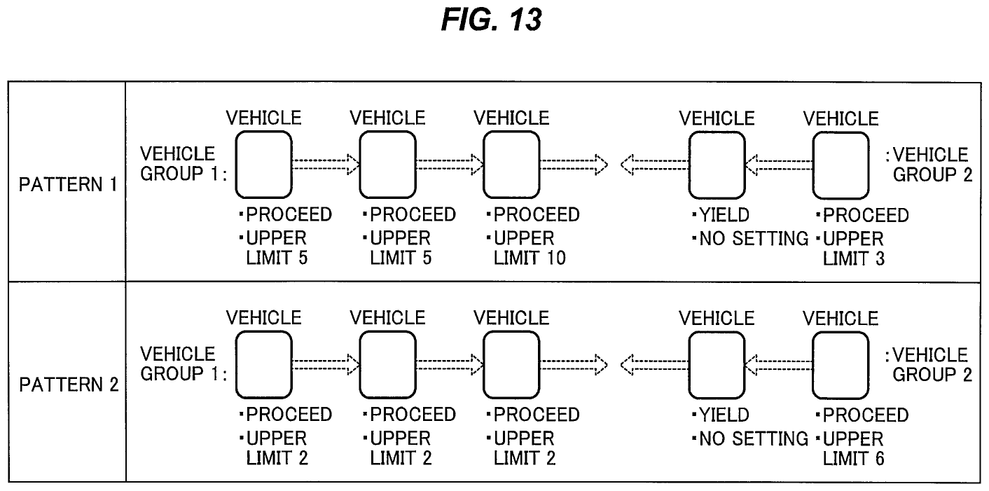

FIG. 13 is a schematic diagram for explaining a specific example of the decision of changing a travel path change and the determination of payment points in the second embodiment.

In Pattern 1 in FIG. 13, the points payable by Vehicle Group 1 is 20 (=10+5+5), and since the points payable by Vehicle Group 2 is 3, the vehicles in Vehicle Group 1 proceed, while the vehicles in Vehicle Group 2 yield. In this case, the users boarding the vehicles in Vehicle Group 1 pay 4 points, which is determined by adding “1” to the 3 payable points of Vehicle Group 2, to the users boarding the vehicles in Vehicle Group 2. The points to be paid to users boarding vehicles in Vehicle Group 2 may be distributed through any method so long as the method is predetermined. If the stance is “yield,” the payment points may be waived.

In the Pattern 2 in FIG. 13, the points payable by Vehicle Group 1 is 6 (=2+2+2), and the points payable by Vehicle Group 2 is also 6; therefore, the Vehicle Group 2 proceeds, for example, depending on which group the user whose payable points is the highest belongs to or depending on the users' history. In this case, “6” points, which is the points payable by Vehicle Group 2, are paid to the users boarding the vehicles in Vehicle Group 1. In this case, each of the users boarding the vehicles in Vehicle Group 2 pays points set as each of their payable points. The points may be distributed to the users boarding the vehicles in Vehicle Group 1 through any method, so long as the method is predetermined. The users boarding the vehicles in Vehicle Group 2 may share the payment of points through any method, so long as the method is predetermined.

What is claimed is:

1. An information management device comprising:
storage to store setting information indicating stance and payable points and history information indicating history of each user, the stance indicating whether a user boarding a host vehicle is to yield to a target vehicle or is to be given way by the target vehicle when a travel path of the host vehicle intersects a travel path of the target vehicle, the payable points being an upper limit of payment points to be paid to the user boarding the target vehicle when the target vehicle changes the travel path to give right of way to the host vehicle;
a processor to execute a program; and
a memory to store the program which, when executed by the processor, performs processes of, determining whether a first vehicle or a second vehicle is to change the travel path and determining the payment points by referring to the setting information when a first traveling device mounted to the first vehicle and controlling traveling of the first vehicle detects the second vehicle, and by comparing the stance and the payable points of a first user boarding the first vehicle with the stance and the payable points of a second user boarding the second vehicle, the second vehicle being the target vehicle of the first vehicle, wherein
when the stance of the first user and the stance of the second user are different, the processor changes the travel path of the vehicle boarded by a user who is set to yield to the target vehicle and sets predetermined points as the payment points; and
when the stance of the first user and the stance of the second user both indicate yielding to the target vehicle, the processor changes the travel path of the vehicle having fewer payable points and sets a number of points equal to or larger than the fewer payable points as the payment points, whereas if the payable points payable by the first user and the payable points payable by the second user are the same, the processor refers to the history information, calculates intensity, changes the travel path of the user having lower intensity, and sets predetermined points as the payment points, the intensity increasing as the number of times the user has been given right of way increases.

2. The information management device according to claim 1, further comprising:
a network communication unit configured to establish communication between a second traveling device mounted on the second vehicle and controlling traveling of the second vehicle and the first traveling device via a network,
wherein the comparator unit sends an instruction to change the travel path to one of the traveling devices via the network communication unit.

3. The information management device according to claim 1, wherein the processor calculates the intensity by multiplying the number of times by a value that decrease as the number of elapsed days from the last time the host vehicle has been given right of way.

4. The information management device according to claim 2, wherein the processor calculates the intensity by multiplying the number of times by a value that decrease as the number of elapsed days from the last time the host vehicle has been given right of way.

5. An information management device comprising:
storage to store setting information indicating stance and payable points, the stance indicating whether a user boarding a host vehicle is to yield to a target vehicle or is to be given way by the target vehicle when a travel path of the host vehicle intersects a travel path of the target vehicle, the payable points being an upper limit of payment points to be paid to the user boarding the target vehicle when the target vehicle changes the travel path to give right of way to the host vehicle;
a processor to execute a program; and
a memory to store the program which, when executed by the processor, performs processes of,
determining whether a first vehicle or a second vehicle is to change the travel path and determining the payment points by referring to the setting information when a first traveling device mounted to the first vehicle and controlling traveling of the first vehicle detects the second vehicle, and by comparing the stance and the payable points of a first user boarding the first vehicle with the stance and the payable points of a second user boarding the second vehicle, the second vehicle being the target vehicle of the first vehicle,
wherein when the first vehicle belongs to a first vehicle group, and the second vehicle belongs to a second vehicle group, the processor calculates a sum of payable points payable by users boarding the first vehicle group, and a sum of payable points payable by users boarding the second vehicle group, changes the travel path of the vehicle group of a smaller sum, and sets payment points by causing the vehicle group of a larger sum to share payment of points equal to or more than the sum of the vehicle group of a smaller sum, the first vehicle group comprising a plurality of vehicles sharing at least a portion of the travel path of the first vehicle, the second vehicle group comprising a plurality of vehicles sharing at least a portion of the travel path of the second vehicle.

6. The information management device according to claim 5, wherein when the sum of the first vehicle group and the sum of the second vehicle group are the same, the comparator unit changes the travel path of the vehicle group not including a user whose payable points are set to a maximum number among the users boarding the first vehicle group and the second vehicle group, and distributes the sum to the vehicle group whose travel path has been changed through a predetermined method.

7. The information management device according to claim 5, wherein,
the information storage unit further stores history information indicating history of each user, and
when the sum of the first vehicle group and the sum of the second vehicle group are the same, the comparator unit changes the travel path of the vehicle group not including a user who has paid the payment points for a maximum number of times among the users boarding the first vehicle group and the second vehicle group, and distributes the sum to the vehicle group whose travel path has been changed through a predetermined method.

8. A service provision system comprising:
a plurality of traveling devices mounted on a plurality of vehicles and controlling traveling of the plurality of vehicles; and
an information management device,
wherein the information management device comprises:
storage to store setting information indicating stance and payable points and history information indicating history of each user, the stance indicating whether a user boarding a host vehicle is to yield to a target vehicle or is to be given way by the target vehicle when a travel path of the host vehicle intersects a travel path of the target vehicle, the payable points being an upper limit of payment points to be paid to the user boarding the target vehicle when the target vehicle changes the travel path to give right of way to the host vehicle;
a processor to execute a program; and
a memory to store the program which, when executed by the processor, performs processes of, determining whether a first vehicle or a second vehicle is to change the travel path and determining the payment points by referring to the setting information when a first traveling device mounted to the first vehicle and controlling traveling of the first vehicle detects the second vehicle, and by comparing the stance and the payable points of a first user boarding the first vehicle with the stance and the payable points of a second user boarding the second vehicle, the second vehicle being the target vehicle of the first vehicle,
wherein when the stance of the first user and the stance of the second user are different, the processor changes the travel path of the vehicle boarded by a user who is set to yield to the target vehicle and sets predetermined points as the payment points; and
wherein when the stance of the first user and the stance of the second user both indicate yielding to the target vehicle, the processor changes the travel path of the vehicle having fewer payable points and sets a number of points equal to or larger than the fewer payable points as the payment points, whereas if the payable points payable by the first user and the payable points payable by the second user are the same, the processor refers to the history information, calculates intensity, changes the travel path of the user having lower intensity, and sets predetermined points as the payment points, the intensity increasing as the number of times the user has been given right of way increases.

9. A service provision system comprising:
a plurality of traveling devices mounted on a plurality of vehicles and controlling traveling of the plurality of vehicles; and
an information management device,
wherein the information management device comprises:
storage to store setting information indicating stance and payable points, the stance indicating whether a user boarding a host vehicle is to yield to a target vehicle or is to be given way by the target vehicle when a travel path of the host vehicle intersects a travel path of the target vehicle, the payable points being an upper limit of payment points to be paid to the user boarding the target vehicle when the target vehicle changes the travel path to give right of way to the host vehicle;
a processor to execute a program; and
a memory to store the program which, when executed by the processor, performs processes of, determining whether a first vehicle or a second vehicle is to change the travel path and determining the payment points by referring to the setting information when a first traveling device mounted to the first vehicle and controlling traveling of the first vehicle detects the second vehicle, and by comparing the stance and the payable points of a first user boarding the first vehicle with the stance and the payable points of a second user boarding the second vehicle, the second vehicle being the target vehicle of the first vehicle,
wherein when the first vehicle belongs to a first vehicle group, and the second vehicle belongs to a second vehicle group, the processor calculates a sum of payable points payable by users boarding the first vehicle group, and a sum of payable points payable by users boarding the second vehicle group, changes the travel path of the vehicle group of a smaller sum, and sets payment points by causing the vehicle group of a larger sum to share payment of points equal to or more than the sum of the vehicle group of a smaller sum, the first vehicle group comprising a plurality of vehicles sharing at least a portion of the travel path of the first vehicle, the second vehicle group comprising a plurality of vehicles sharing at least a portion of the travel path of the second vehicle.

10. A non-transitory computer-readable storage medium storing a program that causes a computer to execute processing comprising:
storing setting information indicating stance and payable points and history information indicating history of each user, the stance indicating whether a user boarding a host vehicle is to yield to a target vehicle or is to be given way by the target vehicle when a travel path of the host vehicle intersects a travel path of the target vehicle, the payable points being an upper limit of payment points to be paid to the user boarding the target vehicle when the target vehicle changes the travel path to give right of way to the host vehicle;
determining whether a first vehicle or a second vehicle is to change the travel path and determining the payment points by referring to the setting information when a first traveling device mounted to the first vehicle and controlling traveling of the first vehicle detects the second vehicle, and comparing the stance and the payable points of a first user boarding the first vehicle with the stance and the payable points of a second user boarding the second vehicle, the second vehicle being the target vehicle of the first vehicle,
wherein when the stance of the first user and the stance of the second user are different, the computer changes the travel path of the vehicle boarded by a user who is set to yield to the target vehicle and sets predetermined points as the payment points; and
wherein when the stance of the first user and the stance of the second user both indicate yielding to the target vehicle, the computer changes the travel path of the vehicle having fewer payable points and sets a number of points equal to or larger than the fewer payable points as the payment points, whereas if the payable points payable by the first user and the payable points payable by the second user are the same, the computer refers to the history information, calculates intensity, changes the travel path of the user having lower intensity, and sets predetermined points as the payment points, the intensity increasing as the number of times the user has been given right of way increases.

11. A non-transitory computer-readable storage medium storing a program that causes a computer to execute processing comprising:
storing setting information indicating stance and payable points, the stance indicating whether a user boarding a host vehicle is to yield to a target vehicle or is to be given way by the target vehicle when a travel path of the host vehicle intersects a travel path of the target vehicle, the payable points being an upper limit of payment points to be paid to the user boarding the target vehicle when the target vehicle changes the travel path to give right of way to the host vehicle;
determining whether a first vehicle or a second vehicle is to change the travel path and determining the payment points by referring to the setting information when a first traveling device mounted to the first vehicle and controlling traveling of the first vehicle detects the second vehicle, and comparing the stance and the payable points of a first user boarding the first vehicle with the stance and the payable points of a second user boarding the second vehicle, the second vehicle being the target vehicle of the first vehicle,
wherein when the first vehicle belongs to a first vehicle group, and the second vehicle belongs to a second vehicle group, the computer calculates a sum of payable points payable by users boarding the first vehicle group, and a sum of payable points payable by users boarding the second vehicle group, changes the travel path of the vehicle group of a smaller sum, and sets payment points by causing the vehicle group of a larger sum to share payment of points equal to or more than the sum of the vehicle group of a smaller sum, the first vehicle group comprising a plurality of vehicles sharing at least a portion of the travel path of the first vehicle, the second vehicle group comprising a plurality of vehicles sharing at least a portion of the travel path of the second vehicle.

12. An information management method comprising:
referring to setting information indicating stance and payable points when a first traveling device mounted on a first vehicle and controlling traveling of the first vehicle detects a second vehicle being a target vehicle traveling a travel path intersecting the travel path of the first vehicle, to compare the stance and the payable points of a first user boarding the first vehicle and the stance and the payable points of a second user boarding the second vehicle, the stance indicating whether a user boarding a host vehicle is to yield to a target vehicle traveling a travel path intersecting the travel path of the host vehicle or the user is to receive right of way from the target vehicle, the payable points being an upper limit of payment points to be paid to a user boarding the target vehicle when the host vehicle receives right of way from the target vehicle as a result of the target vehicle changing the travel path; and
determining whether the first vehicle or the second vehicle is to change the travel path and determining the payment points,
wherein when the stance of the first user and the stance of the second user are different, the travel path of the vehicle boarded by a user who is set to yield to the target vehicle is changed and predetermined points is set as the payment points; and
wherein when the stance of the first user and the stance of the second user both indicate yielding to the target vehicle, the travel path of the vehicle having fewer payable points is changed and a number of points equal to or larger than the fewer payable points is set as the payment points, whereas if the payable points payable by the first user and the payable points payable by the second user are the same, history information is referred to, intensity is calculated, the travel path of the user having lower intensity is changed, and predetermined points is set as the payment points, the history information indicating history of each user, the intensity increasing as the number of times the user has been given right of way increases.

13. An information management method comprising:
referring to setting information indicating stance and payable points when a first traveling device mounted on a first vehicle and controlling traveling of the first vehicle detects a second vehicle being a target vehicle traveling a travel path intersecting the travel path of the first vehicle, to compare the stance and the payable points of a first user boarding the first vehicle and the stance and the payable points of a second user boarding the second vehicle, the stance indicating whether a user boarding a host vehicle is to yield to a target vehicle traveling a travel path intersecting the travel path of the host vehicle or the user is to receive right of way from the target vehicle, the payable points being an upper limit of payment points to be paid to a user boarding the target vehicle when the host vehicle receives right of way from the target vehicle as a result of the target vehicle changing the travel path; and
determining whether the first vehicle or the second vehicle is to change the travel path and determining the payment points,
wherein when the first vehicle belongs to a first vehicle group, and the second vehicle belongs to a second vehicle group, a sum of payable points payable by users boarding the first vehicle group and a sum of payable points payable by users boarding the second vehicle group are calculated, the travel path of the vehicle group of a smaller sum is changed, and payment points is set by causing the vehicle group of a larger sum to share payment of points equal to or more than the sum of the vehicle group of a smaller sum, the first vehicle group comprising a plurality of vehicles sharing at least a portion of the travel path of the first vehicle, the second vehicle group comprising a plurality of vehicles sharing at least a portion of the travel path of the second vehicle.
